(19) United States
(12) Patent Application Publication
(10) Pub. No.: US 2025/0071202 A1
(43) Pub. Date: Feb. 27, 2025

(54) SYSTEMS AND METHODS FOR IMPROVED AGENT-CLIENT CALL INTERACTIONS

(71) Applicant: ROYAL BANK OF CANADA, Toronto (CA)

(72) Inventors: Dylan DAYA, Toronto (CA); Steven PHAN, Toronto (CA); Andrew WEI, Toronto (CA); Neha Sudhir HIMANE, Toronto (CA); Curtis RYAN, Toronto (CA); Domenic PAGNIELLO, Toronto (CA)

(21) Appl. No.: 18/812,205

(22) Filed: Aug. 22, 2024

Related U.S. Application Data
(60) Provisional application No. 63/534,268, filed on Aug. 23, 2023.

(51) Int. Cl. H04M 3/42; G10L 15/26

(52) U.S. Cl. CPC H04M 3/42221; G10L 15/26

(57) ABSTRACT

A transcript of a call between a client and agent can be provided in real-time or near real-time and used to present links to relevant knowledge documents to the agent during the call. The call transcript can be automatically summarized and stored after the call.

### RELATED APPLICATIONS

The current application claims priority to U.S. Provisional Application 63/534,268 titled “Systems and Methods for Improved Agent-Client Call Interactions,” filed Aug. 23, 2023, the entire contents of which are incorporated herein by reference for all purposes.

### TECHNICAL FIELD

The current disclosure relates to systems and methods for use by an agent during client calls, and in particular to systems and methods for improving the interactions between the agent and client during calls.

### BACKGROUND

Call centers or similar environments are used for handling support calls as well as other calls such as sales calls. During such calls an agent will interact with a client or customer in an attempt to achieve the desired outcome, whether that is answering a client's question, solving a problem, selling a product or service, etc. An agent may look-up various information, either from internal resources such as a document repository, and/or from external resources such as the Internet. Looking up such information may require the agent to put the client on hold in order to search for and locate the desired information. In addition to providing a poor client experience by placing the client on hold, such searching may also increase the length of time required by the agent to handle the call.

Often in call centers, or similar environments, the agent must document the call once the call ends. In order to properly document a call the agent may take notes about the call during the call. The agent may need to pause during the conversation to make such notes which can provide an undesirable client experience as well as slowing the overall call handling.

An additional, alternative and/or improved system and/or method for use during agent-client calls to improve the agent-client interactions is desirable.

### BRIEF DESCRIPTION OF THE DRAWINGS

Further features and advantages of the present disclosure will become apparent from the following detailed description, taken in combination with the appended drawings, in which:

FIG. 1 depicts a system for use in improving agent-client interactions during a call;

FIG. 2 depicts an illustrative user interface for an agent during a call;

FIG. 3 depicts an illustrative user interface for an agent after a call;

FIG. 4 depicts a process for presenting topical documents to an agent during a call;

FIG. 5 depicts a method for presenting topical documents to an agent during a call;

FIGS. 6A, 6B depict a further method for presenting topical documents to an agent during a call;

FIG. 7 depicts a method of automatically summarizing a call;

FIG. 8 depicts a further method of automatically summarizing a call; and

FIG. 9 depicts a method of generating prompts for use in summarizing a call.

### DETAILED DESCRIPTION

In accordance with the present disclosure there is provided a method for improving agent-user interactions for a phone call, the method comprising: recording a phone call between a client and an agent; generating real-time transcript chunks from the recording of the phone call; determining an input query phrase from one or more of the real-time transcript chunks; applying the determined input query phrase to a pre-determined embedding model to generate an input feature embedding for the input query phrase; retrieving a number, n, of links associated document links, each associated with respective link feature embeddings that are the closest n link feature embeddings to the input feature embedding, each of the link feature embeddings generated by applying the pre-determined embedding model to a document text indicated by the respective link; displaying to the agent one or more of the retrieved n links; receiving from the agent a selection of one of the one or more displayed links; and retrieving and displaying the document text indicated by the link to the agent.

In a further embodiment of the method, recording the phone call comprises: recording an agent portion of the phone call from a microphone source; and recording a client portion of the phone call from a speaker source.

In a further embodiment of the method, the method further comprises cleaning the real-time transcript chunks to remove extraneous words or text.

In a further embodiment of the method, the input query phrase is generated from a plurality of real-time transcript chunks combined together.

In a further embodiment of the method, the method further comprises removing duplicate start and/or end words or phrases from transcript chunks that are combined together.

In a further embodiment of the method, the input query phrase has a maximum length.

In a further embodiment of the method, the method further comprises: generating a transcript log from the transcript chunks.

In a further embodiment of the method, the method further comprises: upon termination of the phone call, automatically generating a summary of the phone call using at least the transcript log; and displaying the generated summary to the agent.

In a further embodiment of the method, the method further comprises receiving from the agent a modification to the generated summary.

In a further embodiment of the method, the method further comprises displaying the transcript log with the summary of the phone call.

In a further embodiment of the method, the method further comprises passing the one or more transcript chunks to a fraud detection machine learning model and displaying an indication of the results of the fraud detection machine learning model to the agent.

In a further embodiment of the method, the method further comprises passing the one or more transcript chunks to a social engineering detection machine learning model and displaying an indication of the results of the social engineering detection machine learning model to the agent.

In accordance with the present disclosure there is further provided a method for automatically generating a call summary, the method comprising: receiving a call transcript of a call audio to be summarized; determining at least one scenario of a plurality of predefined scenarios that apply to the call transcript; retrieving one or more pre-defined prompts based on the determined at least one scenario; combining the retrieved one or more pre-defined prompts with the call transcript to generate respective summary prompts; applying the respective summary prompts to a large language model to generate respective call summaries; and storing the respective call summaries.

In a further embodiment of the method, the method further comprises redacting personally identifiable information from the call transcript prior to applying to the large language model.

In a further embodiment of the method, the call summary matches a predefined format.

In a further embodiment of the method, the method further comprises, prior to storing the respective call summaries, presenting the respective call summaries to an agent for review for approval.

In accordance with the present disclosure there is further provided a system for improving agent-user interactions for a phone call, the system comprising: at least one processor; and at least one memory storing instructions which when executed by the at least one processor configure the system to provide a method according to any of the methods described above.

In accordance with the present disclosure there is further provided a non-transitory computer readable memory storing instructions which when executed by at least one processor provide a method according to any of the methods described above.

An agent recommendation system can provide an agent with appropriate resources, such as knowledge documents and/or processes, pooled from internal stores based on detection of topics being discussed during a call between the agent and a client. A real time transcription model can be used to generate a real-time transcript of the call. The transcript can be processed to identify relevant topics and then search and retrieve links to relevant documents. The system and method attempts to provide the agent with the appropriate resource that they need to assist the client at the right time in the call, without having to put the client on hold, manually search for what they need and then dig through links based on the topic or inquire from the client.

The systems and methods described below may help increase agent productivity and efficiency during a call with a client. Using real time transcription the system can listen in to calls and based on the client's original query or the agent follow up will identify key topics, which may include keywords in the conversation and formulate a sentence structure that can generate a question around that topic. The question can then be used to find the exact resource related to that topic from documents including those stored in internal processes and procedures database(s). This will allow the agent to have the appropriate information and/or process they need for that portion of the call at their fingertips without having to place the client on hold to find the solution or take additional time discussing with additional support. The system may present one or more links to the relevant documents to the agent. Further, the systems may continually listen to the call as the conversation topic may change and can provide continuous updates to the agent based on the different conversation topics. The system and method described herein can provide increased agent efficiency, improved customer experiences and can overall help reduce operational costs.

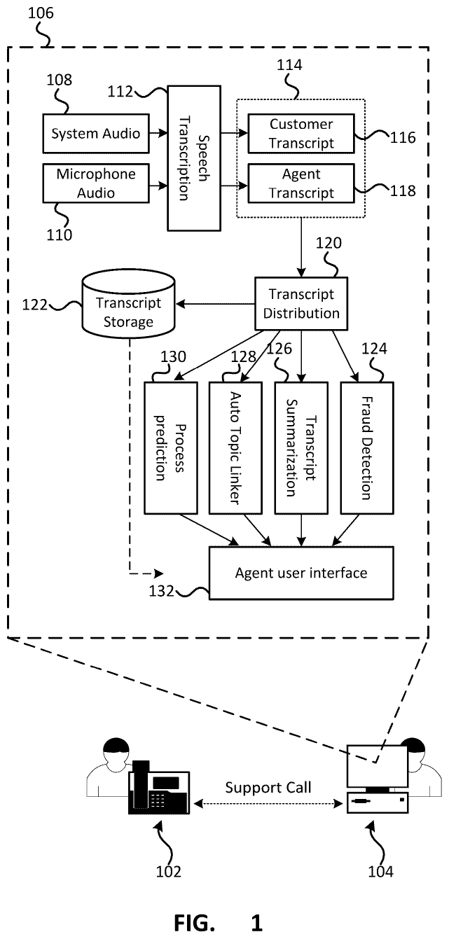

FIG. 1 depicts a system for use in improving agent-client interactions during a call. A client 102 may call into a call center and the call can be passed to a particular agent 104. It will be appreciated that not all of the components supporting the call connection between the client 102 and agent 104 are depicted in FIG. 1. For example, the agent may be in a call center that uses Voice over IP software and call management software to direct the client call to an agent. Regardless of the details of how the client-agent call is established, the call passes through an agent computing device, which may be a computer for the agent or may be a server computing device associated with the call center, that provides various functionality 106 for managing the call as well as providing information to the agent. The functionality 106 may receive system audio 108, which will be a portion of the call having the client's audio portion of the call and microphone audio 110, which will be a portion of the call having the agent's audio portion of the call. Both the system audio and the microphone audio are passed to speech transcription functionality 112 that generates a text transcription 114 from the audio. The text transcription may comprise a client transcript portion 116 and an agent transcript portion 118 generated from the respective audio portions of the call. Alternatively, the separate audio streams could be combined together and a single transcript generated from the audio. The speech transcription functionality may be provided by various automatic speech recognition systems including for example Whisper™ from OpenAI™. The text transcript can be provided in chunks based on portions of the audio. For example, the audio streams may be provided to the transcription functionality in 4 second blocks. It will be appreciated that the audio blocks should be long enough to capture words and possibly full sentences. Longer audio blocks could be used however will increase the latency in the system. For example, if a 15 second audio block is used and the key topic and/or keywords are discussed at the beginning of the audio block it will take at least the 15 seconds until the text transcript is provided and so can be used to provide relevant links or information. Once the transcript chunks are available they can be distributed by distribution functionality to one or more services or functionalities. The transcript distribution functionality 120 may be provided as pub/sub functionality or a messaging queue, a distributed messaging system or other functionality that can distribute the transcript chunks to appropriate services or functionalities. The transcript chunks may be distributed to transcript storage functionality 122 that can store the transcript chunks, or possibly the transcript log created from all of the transcript chunks once the call is completed. Additionally, the transcript chunks, or possibly a complete transcript log, may be provided to fraud detection functionality 124, which may include one or more machine learning models trained to detect various different fraud attempts including possibly identify a call as a social engineering type of fraud. The transcript chunks, or possibly a complete transcript log, can also be provided to transcript summarization functionality 126 that can provide a summary of the call based on the transcript chunks or complete log. Further, the transcript chunks, or possibly a complete transcript log, can be provided to auto topic linking functionality 128 that can determine topics being discussed on the call and automatically present relevant and useful links to the agent in a timely manner. Further, the transcript chunks, or possibly a complete transcript log, can be provided to process prediction functionality 130 that can predict the next steps in the call and present the agent with relevant documents and/or information for the predicted next steps. The results of processing of the transcript chunks, or possibly a complete transcript log, by the various functionality 122, 124, 126, 128, 130 can be provided to an agent user interface functionality 132 that can present the information to the agent during and/or after the call.

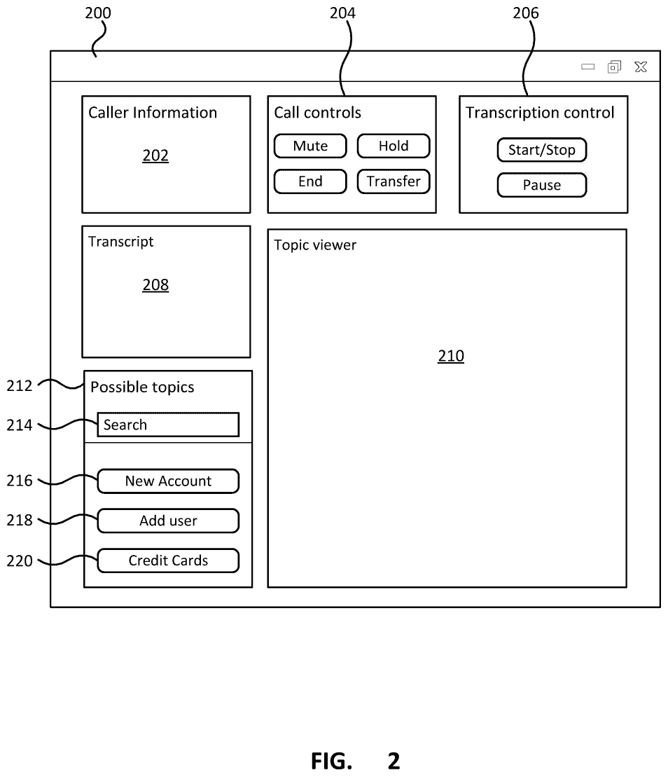

FIG. 2 depicts an illustrative user interface for an agent during a call. The user interface 200 depicted in FIG. 2 is only intended to provide illustrative examples of how the user interface can be presented. The user interface 200 may present various relevant information to the agent and may provide various controls for the agent to interact with the information as well as possibly search for information. For example, the user interface may present caller information 202 such as their name, call history, information about if the client has been authenticated sufficiently, information that may be useful in authenticating the client, etc. The user interface may further provide call controls 204 that allow the agent to control the call such as muting the call, placing the call on hold, transferring the call to another agent or location and ending the call. It will be appreciated that other call controls may be provided. The user interface 200 may also include one or more transcription controls 206 that can be used to start and stop the transcription functionality or to pause it. The transcription functionality may be started automatically when the agent picks up a call or the transcription may be manually started by the agent when desired. The real-time, or near-real-time transcription of the call may be presented to the agent 208. The user interface may provide a viewer 210 or area that presents information to the agent. The viewer may be used to display selected information to the agent. The viewer may be provided within a single window as depicted or may be provided as a separate window such as a separate web browser. The user interface 202 may include a display of links to possibly relevant documents 212 that are automatically determined in real-time, or near real-time from processing the transcript. The topics may be automatically determined from the transcript or may be determined from a manual query 214 of the agent. The links to relevant documents, processes or other resources may be presented to the agent 216, 218, 220 and when clicked on or selected by the agent, the information can be presented to the agent, for example in the viewer 210, for use during the call.

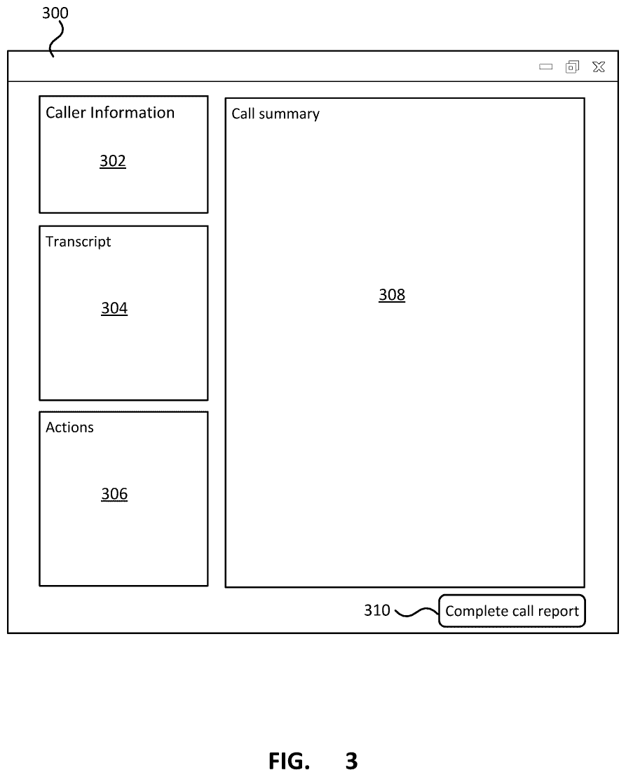

FIG. 3 depicts an illustrative user interface for an agent after a call. In addition to providing a user interface to the agent for use during the call, the systems can also provide a user interface to the agent for use after the call has completed. Typically, an agent must complete a report of some sort following a call. The user interface 300 may be provided to support such report generation. The user interface 300 may present caller information 302 such as the caller's name, etc. as well as call information such as the duration of the call etc. The transcript of the call 304 may be presented to the agent. The transcript may include time information along with the text of the discussion. In addition to presenting the transcript information, the user interface may also present a history of actions taken by the agent, such as clicking on presented links, searching for information, etc. The actions presented may also be presented with time information about when the action occurred. The user interface can present a call summary 308 to the agent. The call summary may be automatically generated from the call transcript, as well as possibly other information such as the actions performed by the agent during the call. The automatically generated call summary may be presented to the agent and may be edited by the agent, either to correct portions of the summary, add additional information to the summary, etc. Once the call report is completed, the agent can click a button or take another action to complete the call report 310 and possibly answer a subsequent call. The after-call interface can help reduce the time taken by the agent to prepare the required call reports.

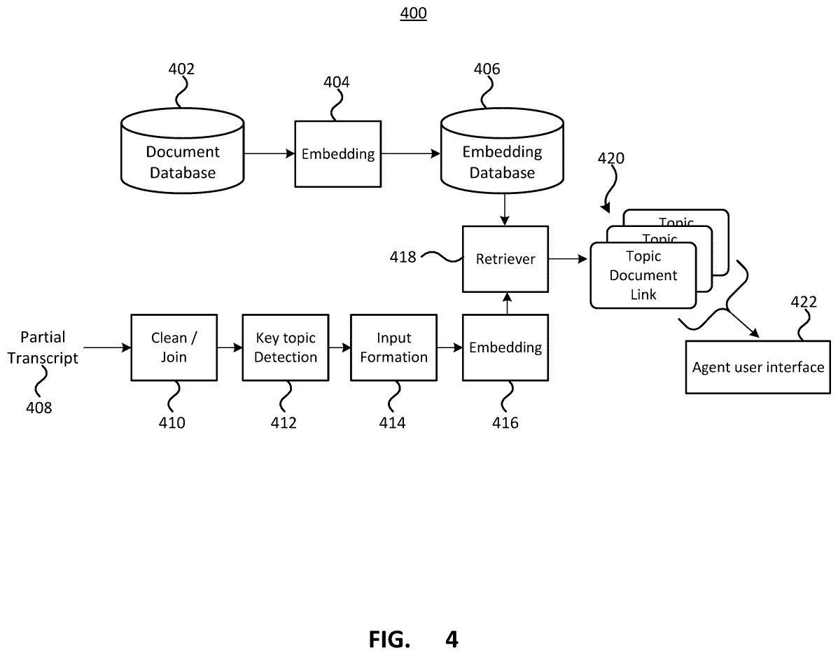

FIG. 4 depicts a process for presenting topical documents to an agent during a call. As described above, audio chunks can be processed to transcript messages or chunks. The partial transcripts may each represent for example a transcription from a block of audio such as 4 or 5 seconds. The system can capture important snippets of a conversation from a stream of automatic transcripts to use as a query in semantic search

The solution provides a way to capture important snippets of a conversation from a stream of automatic speech recognition system transcripts to use as a query in semantic search. Due to the nature of the transcript stream, with partial transcripts formed from sequential blocks of audio, each audio chunk contains samples from a fixed amount of time, thus word boundary issues become apparent in the corresponding transcripts. The word boundary issues may include the same word(s) appearing at the end of a transcript and start of the subsequent transcript. Additionally, punctuation is usually placed in the partial transcript at the end of the audio chunk, regardless of whether or not the end of the audio chunk is also an end of a sentence. In order to generate useful search results, the input search sentence should be provided with sufficient context, without introducing topics from previous transcripts.

As depicted in FIG. 4, a plurality of documents, which may be stored in one or more databases or data stores 402 provide various information on different topics that may be useful or helpful to an agent during a call. For example, the knowledge documents may include information on products and/or services offered, instructions on how to fix a customer issue, processes for performing certain actions, etc. Each of the documents in the internal knowledge database can be indexed by applying a trained embedding model 404 to each document in order to generate a link feature embedding corresponding to the document. Each of the link feature embeddings can be stored in association with a link to the knowledge document the embedding was generated from. The embedding and the link may be stored together in an embedding database 406. The embedding model 404 may comprise a pre-trained models including those based on transformers, such as multi-qa-mpnet-base-dot-v1. The pre-trained model may be a general purpose model or may be tuned for sematic search, document retrieval, or other purposes. The embedding database 406 only needs to be generated once, and possibly updated as new documents are added to the knowledge document database.

The partial transcripts 408 are processed to clean the partial transcripts, such as by removing text representations of sounds, stripping whitespace etc., and join together transcripts as appropriate 410. Key topic detection 410 and input sentence formation 414 can be performed on the cleaned, and possibly joined, portions of the transcripts. The key topic detection processes the transcripts in order to identify key topics in the portion of the transcript. The key topic detection may be based performed in various ways including identifying one or more keywords in the transcript as well as using one or more trained models to identify possible key topics. For example, the key topics may be identified using topic analysis natural language processing techniques. The trained models may be trained using the documents database other training data. The input formation generates a keyword phrase or sentence that can be used in searching the embedding database for relevant documents. The input is provided to an embedding model 416 comprising the same embedding model 404 for the document embeddings. Once the input phrase embedding is generated it is provided to retriever functionality 418 that can retrieve a number of similar document link embeddings from the embedding database 406. For example the retrieval functionality may retrieve the n closest embeddings from the embedding database. It will be appreciated that the number n of closest embeddings that are retrieved can vary. Additionally, the retrieval may also consider a maximum distance beyond which embeddings are not retrieved. For example if there are no close embeddings and so the input phrase does not relate to any documents, no links may be returned. Once the closest link embeddings are determined, the document links 420 associated with the respective embeddings can be provided to an agent user interface 422 for display to the agent. The agent may select one or more of the links and the document from the database 402 may be presented to the agent during the call.

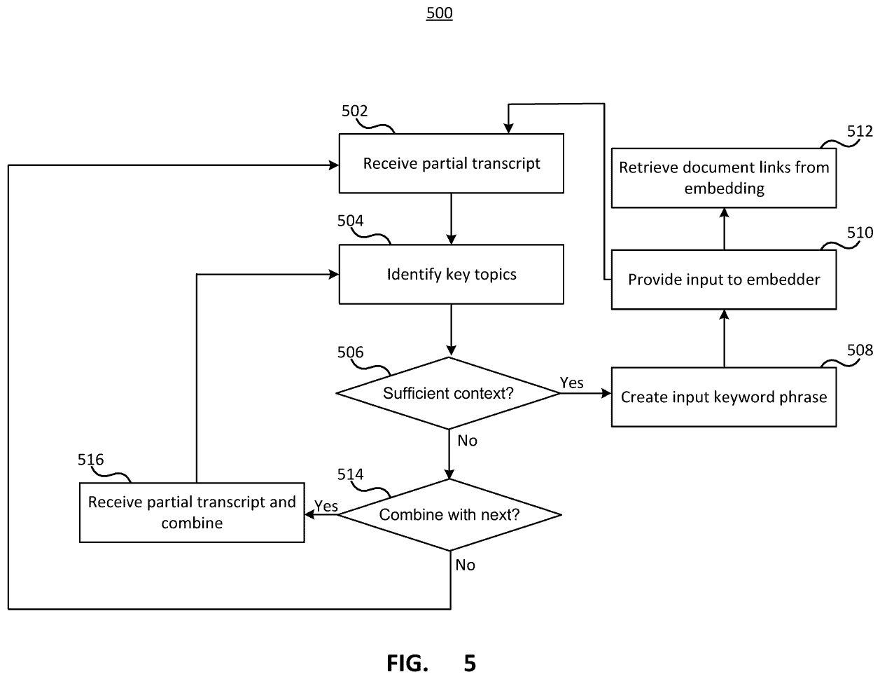

FIG. 5 depicts a method for presenting topical documents to an agent during a call. The method 500 receives a partial transcript (502), which correspond to a transcript from a block of audio, such as 5 seconds. The partial transcript may comprise only the agent portion transcript, only the client portion transcript or both the agent and client portion transcript. Key topics, and/or keywords, can be identified within the partial transcript (504) and it is determined if there is enough context (506) in the partial transcript in order to provide a meaningful input. The determination of if there is sufficient context, may be done in various ways including for example by determining a number of key topics, and/or keywords, present in the partial transcript, determining a length of the partial transcript. If there is sufficient context (Yes at 506) an input keyword phrase is created from the partial transcript (508). The key topic, or keyword, phrase may be generated in various ways including by using the most recent sentence in the transcript as the phrase. The input phrase is provided to the embedding model (510) and the resulting input feature embedding used to retrieve document links from the link embedding database (512). The links can be displayed to an agent in the user interface and subsequently selected for displaying the corresponding document information to the agent. After the input phrase is created the partial transcript can be cleared and the next partial transcript received (502) in order to provide continued searching of the topics discussed. If there is not sufficient context (No at 506), it is determined if the partial transcript should be combined with the next transcript (514). It may be desirable to combine the current transcript with the next transcript when there may be additional context provided by the next block. It may be undesirable to combine the blocks if for example the length of the transcript is already long and as such may not benefit from combining with the next transcript. If the current transcript should be combined with the next transcript (Yes at 516) the next partial transcript is received and combined (518) and the key topics, and/or keywords, can be identified (504) in the combined transcript. If the transcript should not be combined together, the existing partial transcript can be cleared and the next partial transcript received (502).

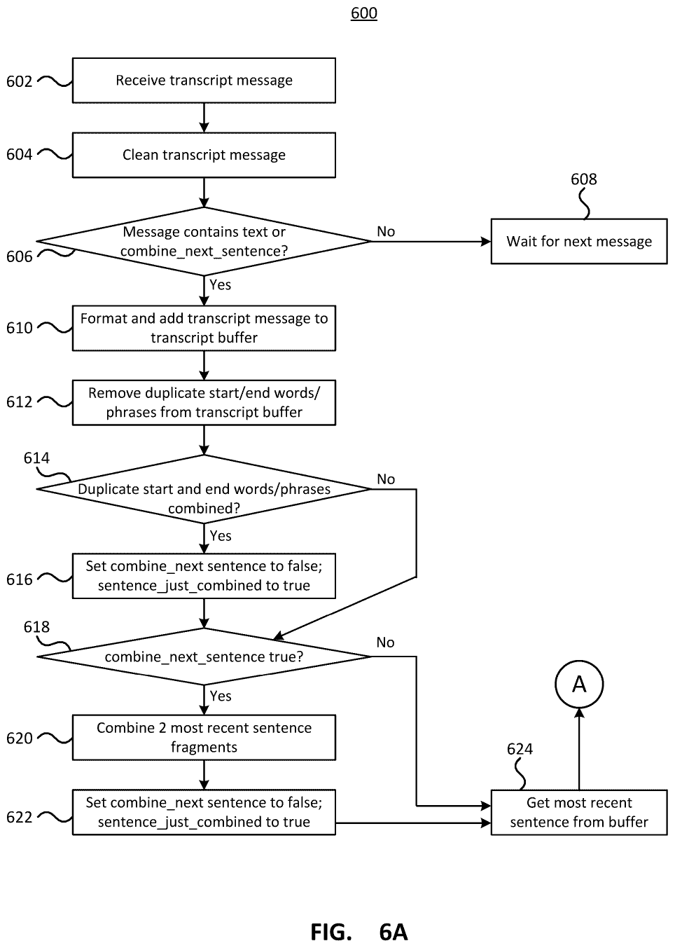

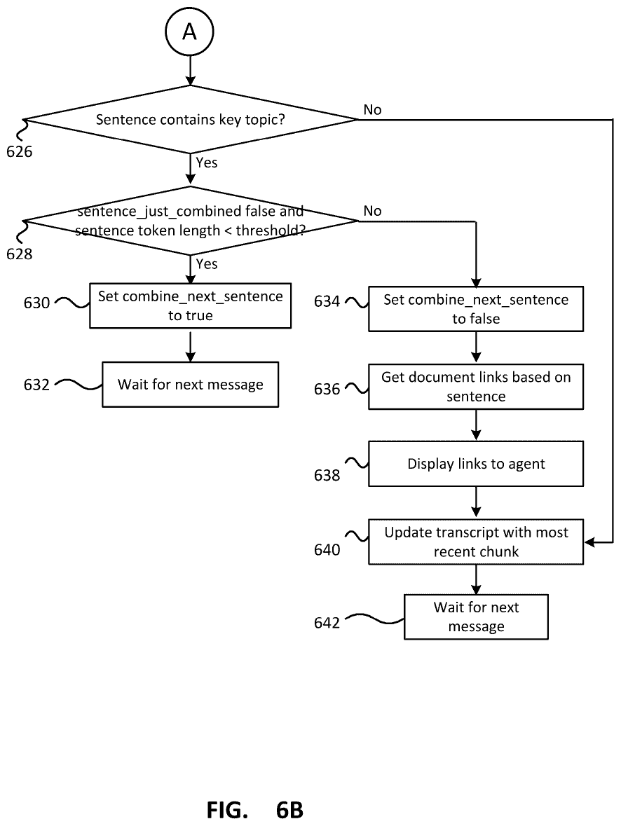

FIGS. 6A, 6B depict a further method for presenting topical documents to an agent during a call. The method 600 receives a transcript message (602) which may comprise text generated from a block of audio. The transcription message may comprise only the text portion of the transcript or may include additional metadata information such as timing information, party identification information, etc. The transcript message can be cleaned (604) to remove extraneous words or text representations including removing excess whitespace. It is determined if the transcript after cleaning contains text, or if a processing flag indicating that the message should be combined with the next sentence (combine_next_sentence) is true (606). If the message does not contain text and it should not be combined with the next sentence (No at 606), the method waits for the next message (608) and processing returns to the beginning when the next message is received (02). If the message contains text or the combine_next_sentence flag is true (Yes at 606) the message is formatted and added to a transcript buffer (610). The formatting may comprise formatting the text to ensure it is in a consistent format including, for example ensuring abbreviations are capitalized, periods at the end of the text are removed, etc. Once added to the transcript buffer, duplicate start and end words or phrases are removed from the buffer. Words may cross the boundaries of the audio blocks and as such words may appear at both the end of one transcript message and the beginning of the subsequent transcript message. The duplicate start/end words typically occur when the audio block boundaries are not aligned with sentence boundaries in the conversation. The method determines if there were duplicate words combined (614) and if there were (Yes at 614) the combine_next_sentence flag is set to false and the sentence_just_combined flag is set to true (616). In this case, it is assumed that a maximum of two sentences should be considered together at a time. If it is desired to combine additional sentences together additional checks or flags could be used. It is determined if the combine_next_sentence flag is true (618) and if it is (Yes at 618) the 2 recent sentence fragments are combined together (620) and the combine_next_sentence flag is subsequently set to false and sentence_just_combined flag set to true (622). After combining the sentence fragments and setting the flags, or if the combine_next_sentence flag is false (No at 618) the most recent sentence is retrieved from the transcript buffer (624) and it is determined if the sentence contains key topics, and/or keywords, (626). If the sentence does contain a key topic and/or keyword (Yes at 626), it is determined if the sentence_just_combined is false and a sentence token length is below a threshold (628), indicating that more context could be provided by combining with another sentence. The threshold may be for example a token length of between 5 and 15 tokens although different token length thresholds may be used. If the sentence_just_combined flag is false and the number of tokens is below the threshold (Yes at 628) the combine_next_sentence flag is set to true (630) and the method waits for the next message (632) and returns to the beginning when a next transcript message is received (602). If the sentence_just_combined flag is true or the sentence token length is equal to or above the threshold (No at 628), the combine_next_sentence flag is set to false (634), and the sentence used to get document links (636). Getting the document links may comprise applying the sentence to the embedding model and determining one or more matching or similar embeddings in a link embedding database. The retrieved links are displayed to the agent (638), which may be selected and the associated document retrieved and displayed to the agent during the call. After the links are retrieved and displayed, or if the sentence has no key topics and/or keywords (No at 626), the transcript is updated with the most recent transcript chunk (640) and the method waits for the next message (632) and returns to the beginning when a next transcript message is received (602).

The above method generates input sentences from transcript blocks that can be used for querying the link embedding database. The method provides sentences that have sufficient context to be useful in retrieving relevant documents, while being succinct enough to have low latency in retrieving the documents during a call. Additionally, while it is desirable to increase the context doing so can potentially cause multiple topics to be contained in one sentence making it difficult to retrieve relevant documents. The method 600 balances the context length to retrieve useful documents in a short time frame making them useful to the agent during the call.

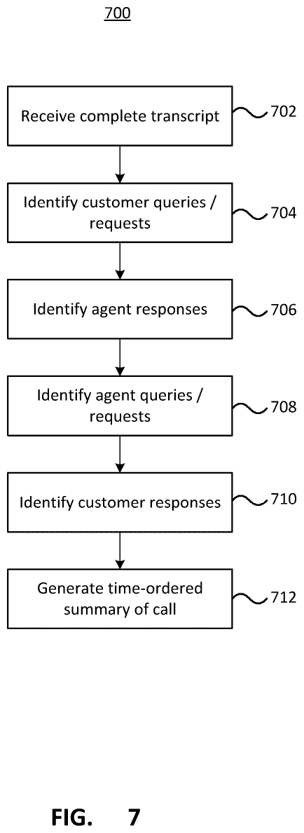

FIG. 7 depicts a method of automatically summarizing a call. As described above, it is possible to summarize a transcript of a call after the call has ended. Doing so may be helpful to the agent who may have to summarize the call as part of a call report. The method 700 receives a complete transcript (702). The complete transcript may comprise a single text file with both the client and agent portions of the transcript or may be provided as separate files. Text of the transcript may be associated with timestamps. From the transcript, client queries and/or requests may be identified (704) and the agent's response to the query or request identified (706). The identification of the queries/requests may be done solely based on the transcript text or may include information from the associated audio such as an intonation of the client's voice. The identification of the agent's response may be based on the timestamps with the agent's discussion following the identified query or request assumed to be the agent's reply. Similarly, the transcripts may be processed to identify queries/requests of the agent (708) along with the responses from the client (710). With the queries and responses identified, a time-ordered summary of the call can be generated (712). Additionally, the transcript text can be processed by one or more models to identify one or more broad subjects discussed during the call. The automatically generated call summary from the transcript can be combined with other information such a particular actions performed by the agent at particular times of the call such as viewing a particular document etc. The call summary can be presented to the agent, possibly along with the complete call transcript and the agent may modify the automatically generated call summary.

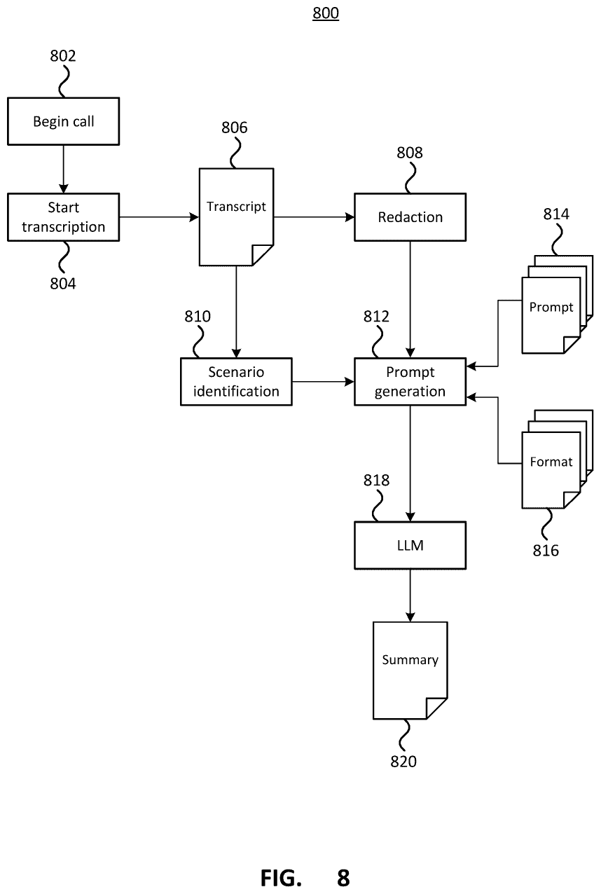

FIG. 8 depicts a further method of automatically summarizing a call. As described above, an agent may have to provide a summary of the call after the call is complete. The call summaries may be required for various reasons including quality control, training, compliance with internal procedures, etc. The call system may store both the audio associated with the call as well as a text transcript of the call. While the transcript can be automatically generated, it can often be difficult to understand what is being discussed or the purpose of the call without reading a significant portion of the transcript. The summaries of calls can provide a succinct summary of the call which can be significantly easier to understand upon a quick reading. The summaries may be provided in a standard format that can make further downstream processing of the summaries easier. As described further below, a large language model (LLM) such as GPT-4.0 turbo or other LLMs) can be used with pre-determined prompts to generate summaries of a call transcript that comply with required formats. The call summaries may be automatically saved, and/or may be presented to the call agent for review and approval, or modification if necessary. The automatic generation of the summary for review by a call agent can be significantly faster, and potentially provide more consistent summaries, compared to an agent manually writing the summaries after the call.

As depicted in FIG. 8 a method 800 can begin with the call starts (802). The beginning of the call may include verifying the caller's identity which may include the caller providing security information. Until the caller's identity is provided and so the security information has been provided, the call may not be recorded, or a transcript started. At some point the transcript will start (804). The transcription may wait until the call is complete in order to generate the complete text transcript from the recorded audio at once, or the transcript may be provided as a live transcript that transcribes the call as it occurs. Regardless, once the completed, a text transcript 806 is available which can be passed for redaction (808). The redaction may process the transcript in order to remove any personally identifiable information (PII). The PII may be removed, or replaced with non-personally identifiable information.

The calls typically involve one or more of a plurality of known scenarios. The transcript 806, or possibly the redacted transcript, can be processed in order to identify the scenario, or scenarios (810), that are relevant to the call transcript. Once the scenario is determined, a prompt can be generated (812) for summarizing the call transcript for the particular scenario. As depicted, there may be a plurality of different pre-determined prompt templates 814 which may be used for different scenarios. Further, different formats 816 for the summary may also be specified. One or more prompts and formats are selected based on the identified scenarios and the selected prompts and formats are combined with the redacted call transcript to generate one or more summary prompts. The prompts and formats may be selected further based on additional factors such as an account type of the caller, a business unit the call is associated with, etc. The generated summary prompts can be submitted to an LLM (818) which generates a summary 820 according to the prompt. The generated summary 820 may be presented to the agent for modification or approval, or the generated summary 820 may be automatically stored without further agent action.

Each call may be associated with multiple scenarios. In such a case, separate summaries can be generated based on different prompts. The different prompts can tailor the summary according to the scenario, and/or other possible requirements.

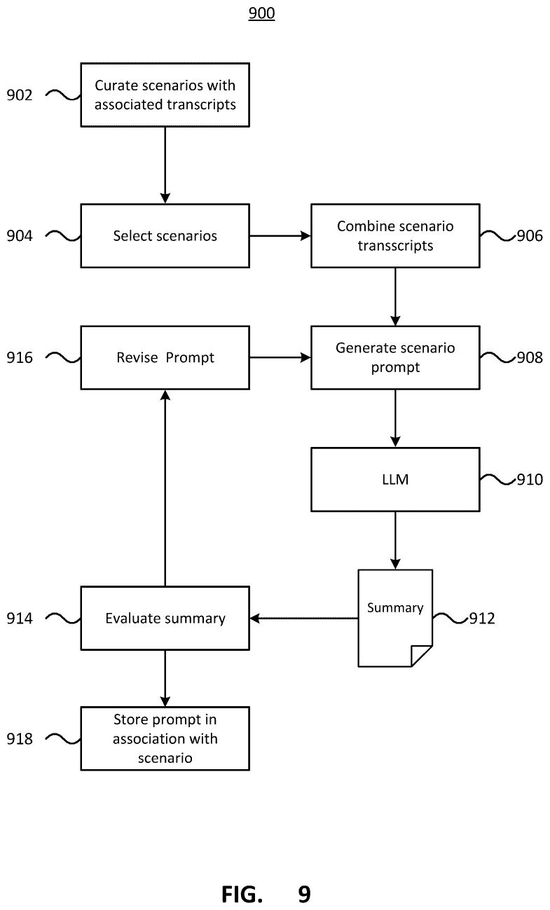

FIG. 9 depicts a method of generating prompts for use in summarizing a call. As described above, different prompts may be used to generate a summary based on the type of scenario associated with the call. Accordingly, applying different prompts to the same transcript may result in different summaries tailored to the particular scenario. In order to generate prompts, different scenarios with the associated transcript portions relevant to that scenario can be curated (902). One or more scenarios can be randomly selected (904) and the associated transcripts of the selected scenarios combined together (906). A prompt for one of the selected scenarios can be selected and applied to the combined transcript (908). The prompt can then be applied to the LLM (910) to generate a summary for the selected scenario (912). The generated summary can be evaluated (914) to determine if the summary is appropriate for the selected scenario, even when the transcript includes multiple scenarios. If it is determined that the summary can be improved, the prompt used for the selected scenario is revised (916) and applied to the combined scenario transcript (908). If the summary is acceptable, the prompt can e stored as a template in association with the selected scenario (918). The generated prompt associated with the scenario can then be used to generate appropriate summaries from transcripts whether that was the only scenario discussed on the call or if multiple different scenarios were discussed.21

It will be appreciated by one of ordinary skill in the art that the system and components shown in FIGS. 1-9 can include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method for improving agent-user interactions for a phone call, the method comprising:
recording a phone call between a client and an agent;
generating real-time transcript chunks from the recording of the phone call;
determining an input query phrase from one or more of the real-time transcript chunks;
applying the determined input query phrase to a pre-determined embedding model to generate an input feature embedding for the input query phrase;
retrieving a number, n, of links associated document links, each associated with respective link feature embeddings that are the closest n link feature embeddings to the input feature embedding, each of the link feature embeddings generated by applying the pre-determined embedding model to a document text indicated by the respective link;
displaying to the agent one or more of the retrieved n links;
receiving from the agent a selection of one of the one or more displayed links; and
retrieving and displaying the document text indicated by the link to the agent.

2. The method of claim 2, wherein recording the phone call comprises:
recording an agent portion of the phone call from a microphone source; and
recording a client portion of the phone call from a speaker source.

3. The method of claim 1, further comprising cleaning the real-time transcript chunks to remove extraneous words or text.

4. The method of claim 1, wherein the input query phrase is generated from a plurality of real-time transcript chunks combined together.

5. The method of claim 4, further comprising removing duplicate start and/or end words or phrases from transcript chunks that are combined together.

6. The method of claim 1, wherein the input query phrase has a maximum length.

7. The method of claim 1, further comprising:
generating a transcript log from the transcript chunks.

8. The method of claim 7 further comprising:
upon termination of the phone call, automatically generating a summary of the phone call using at least the transcript log; and
displaying the generated summary to the agent.

9. The method of claim 8, further comprising receiving from the agent a modification to the generated summary.

10. The method of claim 9, further comprising displaying the transcript log with the summary of the phone call.

11. The method of claim 1, further comprising passing the one or more transcript chunks to a fraud detection machine learning model and displaying an indication of the results of the fraud detection machine learning model to the agent.

12. The method of claim 1, further comprising passing the one or more transcript chunks to a social engineering detection machine learning model and displaying an indication of the results of the social engineering detection machine learning model to the agent.

13. A system for improving agent-user interactions for a phone call, the system comprising:
at least one processor; and
at least one memory storing instructions which when executed by the at least one processor configure the system to provide a method according to claim 1.

14. A non-transitory computer readable memory storing instructions which when executed by at least one processor provide a method according to claim 1.

15. A method for automatically generating a call summary, the method comprising:
receiving a call transcript of a call audio to be summarized;
determining at least one scenario of a plurality of predefined scenarios that apply to the call transcript;
retrieving one or more pre-defined prompts based on the determined at least one scenario;
combining the retrieved one or more pre-defined prompts with the call transcript to generate respective summary prompts;
applying the respective summary prompts to a large language model to generate respective call summaries; and
storing the respective call summaries.

16. The method of claim 15, further comprising:
redacting personally identifiable information from the call transcript prior to applying to the large language model.

17. The method of claim 15, wherein the call summary matches a predefined format.

18. The method of claim 15, further comprising, prior to storing the respective call summaries, presenting the respective call summaries to an agent for review for approval.

19. A system for improving agent-user interactions for a phone call, the system comprising:
at least one processor; and
at least one memory storing instructions which when executed by the at least one processor configure the system to provide a method according to claim 15.

20. A non-transitory computer readable memory storing instructions which when executed by at least one processor provide a method according to claim 15.
